(19) United States
(12) Patent Application Publication
(10) Pub. No.: US 2004/0163332 A1
(43) Pub. Date: Aug. 26, 2004

(54) Termite deterrent

(76) Inventor: James D. Raymond, Leonard Boulevard Kent, OH (US)

Correspondence Address: Richard C. Litman, LITMAN LAW OFFICES, LTD., P.O. Box 15035, Arlington, VA, 22215, US

(21) Appl. No.: 10/762,289

(22) Filed: Jan. 23, 2004

Related U.S. Application Data
(60) Provisional application No. 60/448,138, filed on Feb. 20, 2003.

(51) Int. Cl. E04B 1/72; A01K 3/00

(52) U.S. Cl. 52/101

(57) ABSTRACT

A termite deterrent and protective cap placed on top of a pier or a post, and made up of a circular disk with sidewalls that extending downward from the periphery of the circular disk. The cap is placed with the inside surface of the sidewalls not being in contact with the outer walls of the post, while being secured to the top of the post being protected. The circular disk and has a scored inner circular center removed to accommodate a thread rod from the generally circular circumference pier or post that would extend through the plane of the inner circular center. The sidewalls are angled to a perpendicular of the periphery of the circular disk for easy stacking and storage. There is also a square disk embodiment.

### CROSS-REFERENCE TO RELATED APPLICATION

This application claims the benefit of U.S. Provisional Patent Application Serial No. 60/448,138, filed Feb. 20, 2003.

### BACKGROUND OF THE INVENTION

1. Field of the Invention

The present invention relates to a termite deterrent cap that is placed on top of pier posts before construction of carrying timbers are installed on top of the pier posts.

2. Description of Related Art

Construction methods have improved over the last several decades with the development of new and improved materials and construction techniques. These newer construction materials are stronger, lighter and more durable then previously used traditional materials. The development of new and improved plastics and polymers has also resulted in better protected and more efficient buildings and structures. Specifically, protected bases, column supports and caps are provided for improved protection in a number of construction situations and environments. Many of these improvements are reflected in the related art.

U.S. Pat. No. 976,879 issued to Hughs on Nov. 29, 1910, outlines the use of poles for supporting overhead telegraph wires, telephone wires, electric light lines and other wires and cables. The support pole is sunk into the ground and is firmly upheld by a concrete base surrounding the pole with a cap covering the components of these various wires and cables.

U.S. Pat. No. 4,673,157 issued to Wells on Jun. 16, 1987, outlines the use of a one time use footing form useable in concert with conventional (SONOTUBES) of different diameters, so that piers and footings can be poured at the same time. This allows all excavation and backfill to be done in one day prior to the pouring of the concrete. Also the concrete is all poured on the same day, resulting in significant savings in labor costs, as well as expediting the entire project.

U.S. Pat. No. 5,709,057 issued to Johnson, Jr. et al. on Jan. 20, 1998, outlines the use of a post cap and accessory for pilings, poles and posts for preventing piling degradation while providing a mounting platform. The cap is attached to a piling using spring clips for quick attachment, or may be secured by nails or screws. Winged pedestals are provided on top of the cap and around the periphery of the cap's skirt to allow for the ease of attachment of many accessories. Each accessory is equipped, with a grooved base that slides onto the winged pedestals and self-locks. The cap and its pedestals are of homogeneous construction formed simultaneously by plastic injection molding, metal casting or other methods.

U.S. Pat. No. 5,901,525 issued to Doeringer et al. on May 11, 1999, outlines the use of building construction supports, and more particularly, to an elevated base for supporting a wood column's lowermost portion from rot and other deterioration due to exposure to moisture, heat, fungus and parasites such as wood-boring insects, due to exposure to a tropical environment. The column base includes a stanchion, a diaphragm, and a cap, each monolithically molded from a thermoplastic material.

U.S. Pat. No. 5,927,024 issued to Toutountzis et al. on Jul. 27, 1999, outlines the use of a termite barrier particularly suitable for protecting buildings, which have a concrete slab with an object such as a conduit extending through an opening in the slab. The termite barrier is made up of a body having a sleeve defining an aperture extending therethrough to sealingly receive the conduit. The body has an outer peripheral portion defining a flange portion that is adapted to be integrally secured to the concrete slab. The flange portion is provided with a method for gripping engagement with the concrete structure.

U.S. Pat. No. 6,401,411 issued to Maglio, Jr. on Jun. 11, 2002, outlines the use of a post base that is buried in the ground to a depth sufficient to provide the requisite stability. These posts can unfortunately suffer from the detrimental effects of moisture, decay, rotting and pests (such as termites). The post base has an upwardly tapering portion that is at least partially surrounded by a shell, to protect against such detriments. This base also includes a non-tapering portion adjacent to and axially below the upwardly tapering portion.

Although each of these patents outline the use of an invention or development that is useful and novel, what is really needed is a termite deterrent for the tops or caps of concrete and wooden posts or piers that are undergoing construction. This type of specialized construction is particularly susceptible to pest and termite exposure and would be a welcome product in the construction industry.

None of the above inventions and patents, taken either singly or in combination, is seen to describe the instant invention as claimed.

### SUMMARY OF THE INVENTION

The invention is a termite deterrent and protective cap that is placed on top of a generally circular circumference pier or a post during construction. The termite deterrent and protective cap is made of a circular disk with a topside and sidewalls that extend downward from the periphery of the circular disk. The circular disk and sidewalls are placed on top of the generally circular circumference pier or post being protected, with the inside surface of the sidewalls not being in contact with the outer walls of the generally circular circumference pier or post while the termite deterrent and protective cap is fixedly attached and secured to the top of the generally circular circumference pier or post being protected. The circular disk and has a scored inner circular center that can be removed to accommodate a thread rod from the generally circular circumference pier or post that would extend through the plane of the inner circular center. The sidewalls are at a slightly outward angle to a perpendicular of the periphery of the circular disk for easy stacking and storage and the sidewalls and circular disk come together to form a rounded edge on the outer surface of the termite deterrent and protective cap. There is also a square disk embodiment of the invention as well.

Accordingly, it is a principal object of the invention to provide a smooth and contoured termite deterrent cap or top for concrete or wooden posts or piers.

It is another object of the invention to provide a termite deterrent cap to prevent injuries to people playing or working in and around pier and timber foundations.

It is a further object of the invention to provide a termite deterrent cap for concrete or wooden piers that is impervious to material degradation due to rust, corrosion, insects or moisture.

Still another object of the invention is to provide termite deterrent caps for concrete or wooden posts or piers that are easy to stack on top of one another for easy storage.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental perspective view of a termite deterrent cap according to the present invention.

FIG. 2 is a topside perspective view of the first embodiment of the invention.

FIG. 3 is a topside perspective view of the second embodiment of the invention.

Similar reference characters denote corresponding features consistently throughout the attached drawings.

### DETAILED DESCRIPTION OF THE PREFERRED EMBODIMENTS

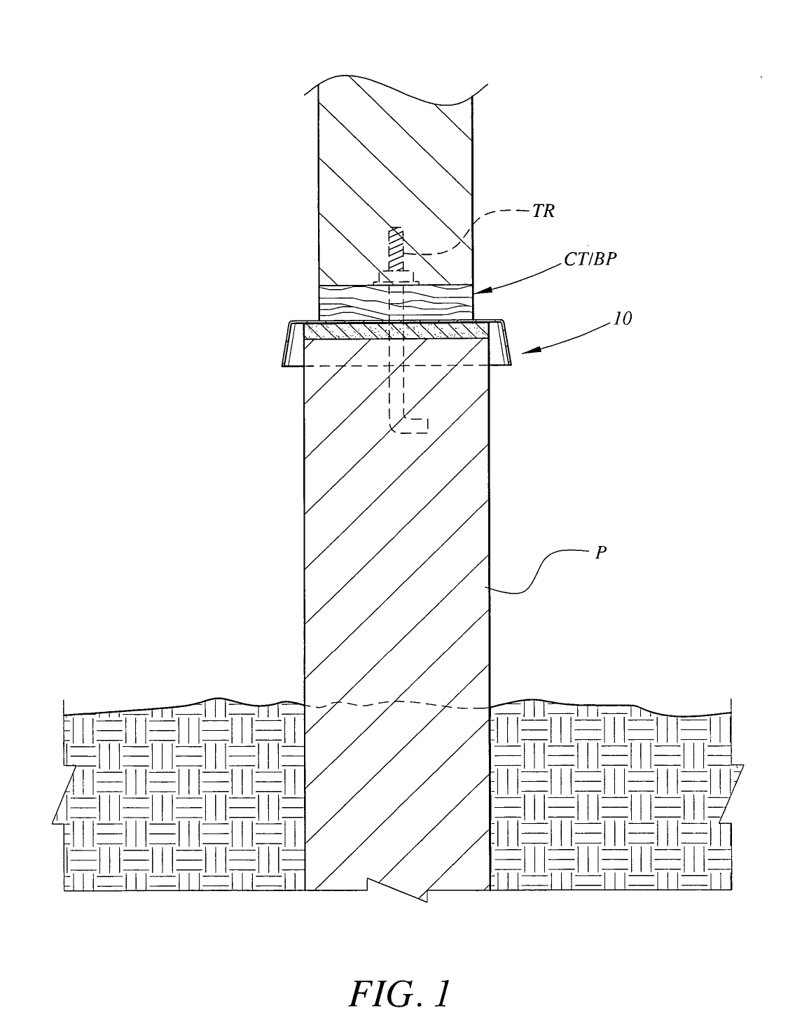

The present invention is a termite deterrent and protective cap 10 that is placed on top of a generally circular circumference pier or post P during construction, as is depicted in FIG. 1. FIG. 1 also depicts a carrying timber CT or bottom plate BP set on top of the termite deterrent and protective cap 10 as well as a threaded rod TR extending through the generally circular-shaped circumference pier or post P and termite deterrent and protective cap 10 and into the carrying timber CT or bottom plate BP.

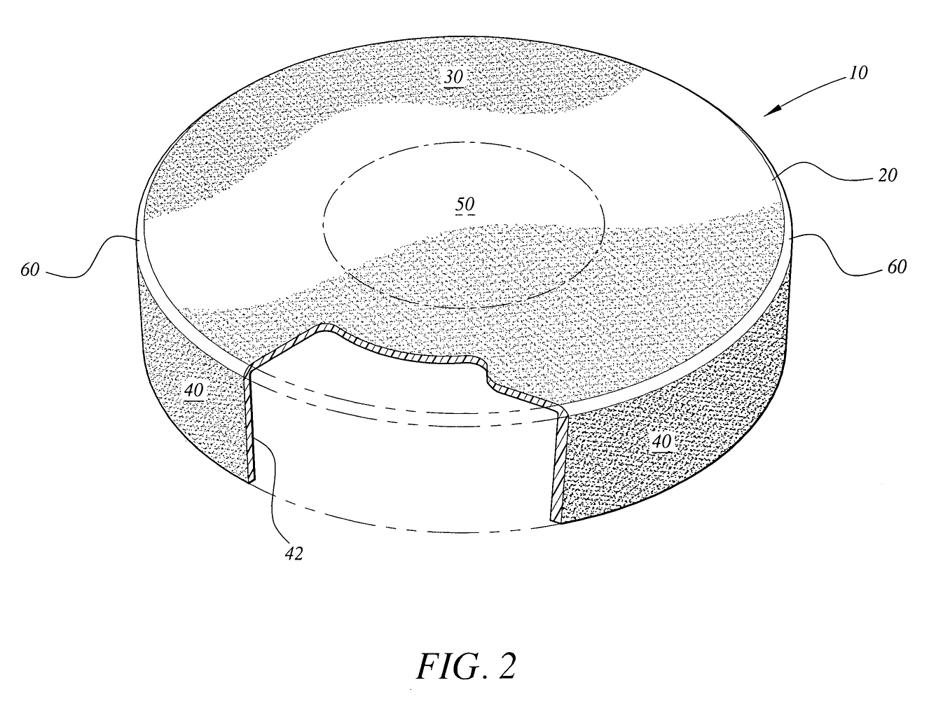

As is shown in FIG. 2, the first embodiment of the termite deterrent and protective cap 10 comprises a circular disk 20 with a topside 30 and sidewalls 40 that extend downward from the periphery of the circular disk 20, with the circular disk 20 and sidewalls 40 being placed on top of the generally circular-shaped circumference pier or post P being protected, with the inside surface of the sidewalls 42 not being in contact with the outer walls of the generally circular circumference pier or post P while the termite deterrent and protective cap 10 is fixedly attached and secured to the top of the generally circular circumference pier or post P being protected. Typically, the diameter of the generally circular circumference pier or post P is 12 inches and the termite deterrent and protective cap 10 is 14 inches in diameter, allowing the termite deterrent and protective cap 10 to be centered with a 1 inch border around the periphery of the generally circular circumference pier or post P.

The circular disk 20 has a scored inner circular center 50 that can be knocked out and removed to accommodate a threaded rod TR (FIG. 1) from the generally circular circumference pier or post P that would extend through the plane of the scored inner circular center 50. The sidewalls 42 are at an approximate three degree outward angle to a perpendicular of the periphery of the circular disk 20 for easy stacking and storage. The sidewalls 40 and circular disk 20 come together to form a rounded edge 60 on the outer surface of the termite deterrent and protective cap 10.

The termite deterrent and protective cap 10 is fixedly attached and secured to the top of the generally circular circumference pier or post P with a generous application of caulking or asphalt. The caulking or asphalt serves to seal the crevice formed between the termite deterrent and protective cap 10 and the top of the generally circular circumference pier or post P. The termite deterrent and protective cap 10 has a smooth and contoured surface that can accommodate generally circular circumference piers or posts P made of concrete or wood.

The termite deterrent and protective cap 10 is designed to comply with local building codes and serve to protect people playing or working in and around the foundation of generally circular circumference piers or posts P. The termite deterrent and protective cap 10 is made of smooth polyethylene, is 14 inches in diameter, with a 6 inch diameter scored inner circular center 50, is 3 inches in height and is uniformly 3/16^{th} of an inch thick.

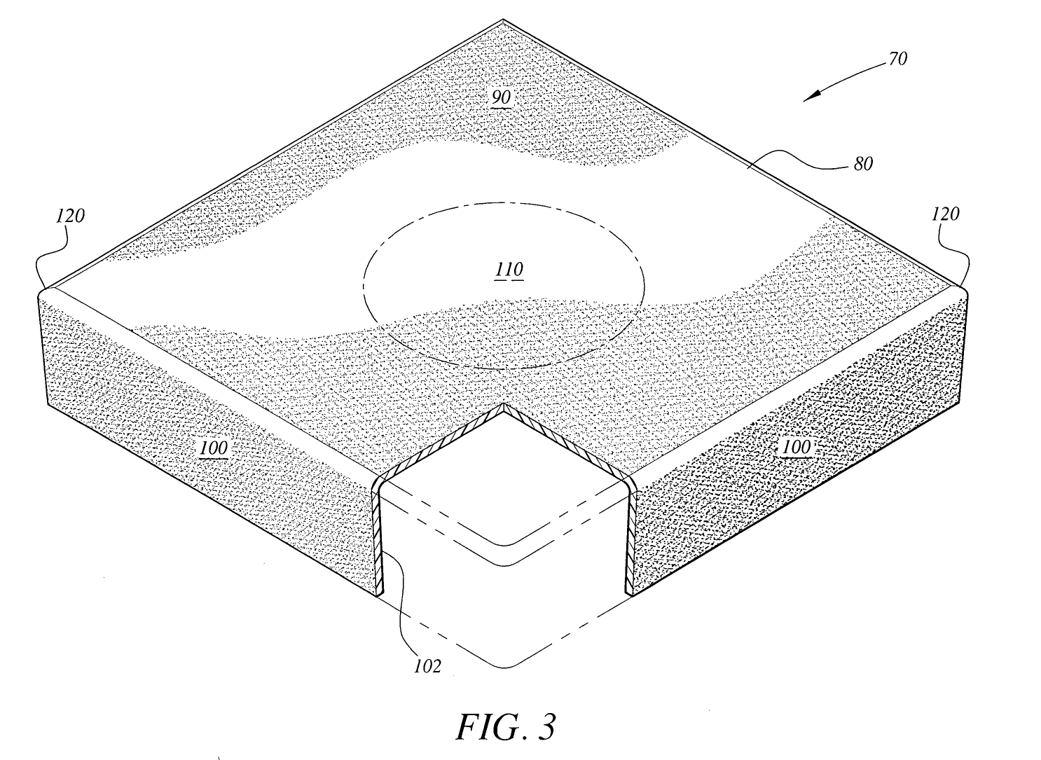

FIG. 3 depicts the second embodiment of the termite deterrent and protective cap 70 that is placed on top of a generally square circumference pier or post P′. The termite deterrent and protective cap 70 comprises a square disk 80 with a topside 90 and sidewalls 100 that extend downward from the periphery of the square disk 80. The square disk 80 and sidewalls 100 are placed over the top of the generally square circumference pier or post P′ being protected, with the inside surface of the sidewalls 102 not being in contact with the outer walls of the generally square circumference pier or post P′ while the termite deterrent and protective cap 70 is fixedly attached and secured to the top of the generally square circumference pier or post P′ being protected. The square disk 80 also has a scored inner circular center 110 that can be removed to accommodate a threaded rod TR (FIG. 1) from the generally square circumference pier or post P′ that would extend through the plane of the scored inner circular center 110.

The sidewalls 100 are at a slightly outward angle to a perpendicular of the periphery of the square disk 80 for easy stacking and storage. The sidewalls 100 and square disk 80 come together to form a rounded edge 120 on the outer surface of the termite deterrent and protective cap 70. The termite deterrent and protected cap 70 is fixedly attached and secured to the top of the square circumference pier or post P′ with caulking or asphalt. The caulking or asphalt serves to seal the crevice formed between the termite deterrent and protective cap 70 and the top of the generally square circumference pier or post P′. The termite deterrent and protective cap 70 has a smooth and contoured surface that can accommodate generally square circumference piers or posts P′ made of concrete or wood.

The termite deterrent and protective cap 70 is designed to comply with local building codes and serve to protect people playing or working in and around the foundation of generally square circumference piers or posts P′. The termite deterrent and protective cap 70 is made of smooth polyethylene, is 14 inches in diameter, with a 6 inch diameter scored inner circular center 50, is 3 inches in height and is uniformly 3/16^{th} of an inch thick.

It is to be understood that the present invention is not limited to the sole embodiments described above, but encompasses any and all embodiments within the scope of the following claims.

I claim:

1. A termite deterrent and protective cap that is placed on top of a generally circular circumference pier or a post during construction, comprising:
a circular disk with a topside, a periphery and sidewalls with an inside surface that extend downward from the periphery of the circular disk, said circular disk and sidewalls placed on top of the generally circular circumference pier or post being protected, with the inside surface of the sidewalls not being in contact with the outer walls of the generally circular circumference pier or post, while said termite deterrent and protective cap are secured to the top of the generally circular circumference pier or post being protected;
said circular disk having a scored inner circular center that can be removed to accommodate a thread rod from the generally circular circumference pier or post that would extend through the plane of the inner circular center;
said sidewalls at a slightly outward angle to a perpendicular of the periphery of the circular disk for easy stacking and storage; and
said sidewalls and circular disk come together to form a rounded edge on the outer surface of the termite deterrent and protective cap.

2. The termite deterrent and protective cap according to claim 1, wherein the termite deterrent and protective cap is secured to the top of the generally circular circumference pier or post with caulking.

3. The termite deterrent and protected cap according to claim 1, wherein the termite deterrent and protective cap is secured to the top of the generally circular circumference pier or post with asphalt.

4. The termite deterrent and protected cap according to claim 1, wherein the termite deterrent and protective cap is made of smooth polyethylene.

5. A termite deterrent and protective cap that is placed on top of a generally square circumference pier or a post during construction, comprising:
a square disk with a topside, a periphery and sidewalls with an inside surface that extend downward from the periphery of the square disk, said square disk and sidewalls placed on top of the generally square circumference pier or post being protected, with the inside surface of the sidewalls not being in contact with the outer walls of the generally square circumference pier or post, while said termite deterrent and protective cap are secured to the top of the generally square circumference pier or post being protected;
said square disk having a scored inner circular center that can be removed to accommodate a thread rod from the generally square circumference pier or post that would extend through the plane of the inner circular center;
said sidewalls at a slightly outward angle to a perpendicular of the periphery of the square disk for easy stacking and storage; and
said sidewalls and square disk coming together to form a rounded edge on the outer surface of the termite deterrent and protective cap.

6. The termite deterrent and protective cap according to claim 5, wherein the termite deterrent and protective cap is secured to the top of the generally square circumference pier or post with caulking.

7. The termite deterrent and protected cap according to claim 5, wherein the termite deterrent and protective cap is secured to the top of the generally square circumference pier or post with asphalt.

8. The termite deterrent and protected cap according to claim 5, wherein the termite deterrent and protective cap is made of smooth polyethylene.
